(19) United States
(12) Patent Application Publication
(10) Pub. No.: US 2017/0126333 A1
(43) Pub. Date: May 4, 2017

(54) METHOD, DEVICE AND SYSTEM FOR PROVIDING RADIO FREQUENCY SIGNALS FOR UNDERWATER COMMUNICATION DEVICE

(71) Applicant: Alleco Oy, Helsinki (FI)

(72) Inventors: Jouni LEINIKKI, Tervalampi (FI); Dennis HAMRO-DROTZ, Helsinki (FI); Vesa HAUTSALO, Espoo (FI); Juhani KANERVA, Nakkila (FI); Panu OULASVIRTA, Helsinki (FI); Juha SYVÄRANTA, Helsinki (FI); Jenni WESTERLUND, Helsinki (FI)

(21) Appl. No.: 15/277,564

(22) Filed: Sep. 27, 2016

(30) Foreign Application Priority Data
Sep. 28, 2015 (FI) 20155687

(51) Int. Cl. H04B 13/02; H04B 7/155

(52) U.S. Cl. CPC H04B 13/02; H04B 7/15528

(57) ABSTRACT

A floating communication device includes a waterproof casing having a wireless communication interface for transceiving data; and an electromagnetic wave radiation cable attached to an external surface of the waterproof casing and inductively coupled to the wireless communication interface to transceive radio frequency signals between the wireless communication interface and an underwater communication device.

### TECHNICAL FIELD

The present application generally relates to a method, a device and a system for providing radio frequency signals for a device underwater. The present application further relates to a casing comprised by the apparatus.

### BACKGROUND ART

Particularly since the introduction of the scuba equipment, people are exploring underwater environments in great numbers.

Simultaneously, the increase in the number of those exploring underwater areas has triggered significant progress in diving-related technology. However, there are still areas, such as wireless communication devices, in which significant needs still exist.

Known solutions exist where a wireless underwater communication device is communicating acoustically with a surface device. Such system does not enable data transfer speed at required level.

Global Positioning System (GPS) and wireless data protocols, such as Wireless Local Area Network (WLAN), Bluetooth and cellular radio, such as GSM, WCDMA and LTE, use radio frequencies that do not penetrate deep into the water. In order to enjoy GPS and Internet services, a diver equipped with an underwater device, such as a tablet computer would need technology to transmit data to and from above the water surface.

A solution is needed for providing an improved solution for providing wireless data communication for an underwater communication device.

### SUMMARY

According to a first example aspect of the invention there is provided a floating communication device comprising:

a waterproof casing comprising a wireless communication interface for transceiving data; and

an electromagnetic wave radiation cable attached to an external surface of the waterproof casing and inductively coupled to the wireless communication interface to transceive radio frequency signals between the wireless communication interface and an underwater communication device.

In an embodiment, the wireless communication interface comprises at least one of the following:

a wireless cellular network interface;

a satellite based positioning system interface; and

a wireless non-cellular network interface.

In an embodiment, the waterproof casing further comprises:

at least one processor; and

at least one memory including computer program code; wherein the at least one memory and the computer program code configured to, with the at least one processor, cause the floating communication device to:
receive data using the wireless communication interface;
convert the received data to radio frequency signals for transmission over the electromagnetic wave radiation cable; and
transmit the radio frequency signals from the wireless communication interface to the underwater communication device.

In an embodiment, the electromagnetic wave radiation cable comprises a passive antenna.

In an embodiment, the passive antenna is arranged above a surface of water.

In an embodiment, the passive antenna is arranged below a surface of water.

According to a second example aspect of the invention there is provided a method for providing radio frequency signals between a floating communication device and an underwater communication device, the method comprising:

receiving data using a wireless communication interface of a floating communication device;

converting the received data to radio frequency signals for transmission over an electromagnetic wave radiation cable; and

transmitting the radio frequency signals from the wireless communication interface of the floating communication device over the electromagnetic wave radiation cable to an underwater communication device.

According to a third example aspect of the invention there is provided an underwater communication device comprising:

a waterproof casing comprising a wireless communication interface for transceiving data; and

an electromagnetic wave radiation cable attached to an external surface of the waterproof casing and inductively coupled to the wireless communication interface to transceive radio frequency signals between the wireless communication interface and a floating communication device.

In an embodiment, the underwater communication device further comprises:

a second electromagnetic wave radiation cable attached to the external surface of the waterproof casing and inductively coupled to the wireless communication interface to transceive radio frequency signals between the wireless communication interface and a second underwater communication device.

In an embodiment, the waterproof casing further comprising:

a passive antenna attachment comprising a shaped element configured to guide a passive antenna to an operating position on a surface of the waterproof casing, wherein the attachment comprising a casing part manufactured from a radio frequency (RF) transparent material to pass radio frequency (RF) signals through the casing.

According to a fourth example aspect of the invention there is provided a system comprising:

a floating communication device of the first aspect; and

an underwater communication device of the third aspect.

According to a fifth example aspect of the invention there is provided computer program embodied on a computer readable medium comprising computer executable program code which, when executed by at least one processor of a floating communication device, causes the floating communication device to:

receive data using a wireless communication interface of the floating communication device;

convert the received data to radio frequency signals for transmission over an electromagnetic wave radiation cable; and

transmit the radio frequency signals from the wireless communication interface of the floating communication device to an underwater communication device.

Different non-binding example aspects and embodiments of the present invention have been illustrated in the foregoing. The above embodiments are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

The invention will be described, by way of example only, with reference to the accompanying drawings, in which:

FIG. 1 shows a schematic picture of a system according to an example embodiment of the invention;

FIG. 2 shows a schematic picture of a floating communication device according to an example embodiment of the invention from a second side;

FIG. 3 presents a schematic view of a capturing device in which various embodiments of the invention may be applied;

FIG. 4 presents a schematic view of a server apparatus in which various embodiments of the invention may be applied;

FIG. 5 presents a schematic view of an underwater communication device in which various embodiments of the invention may be applied; and

FIG. 6 shows a flow diagram showing operations in accordance with an example embodiment of the invention.

### DETAILED DESCRIPTION

In the following description, like numbers denote like elements.

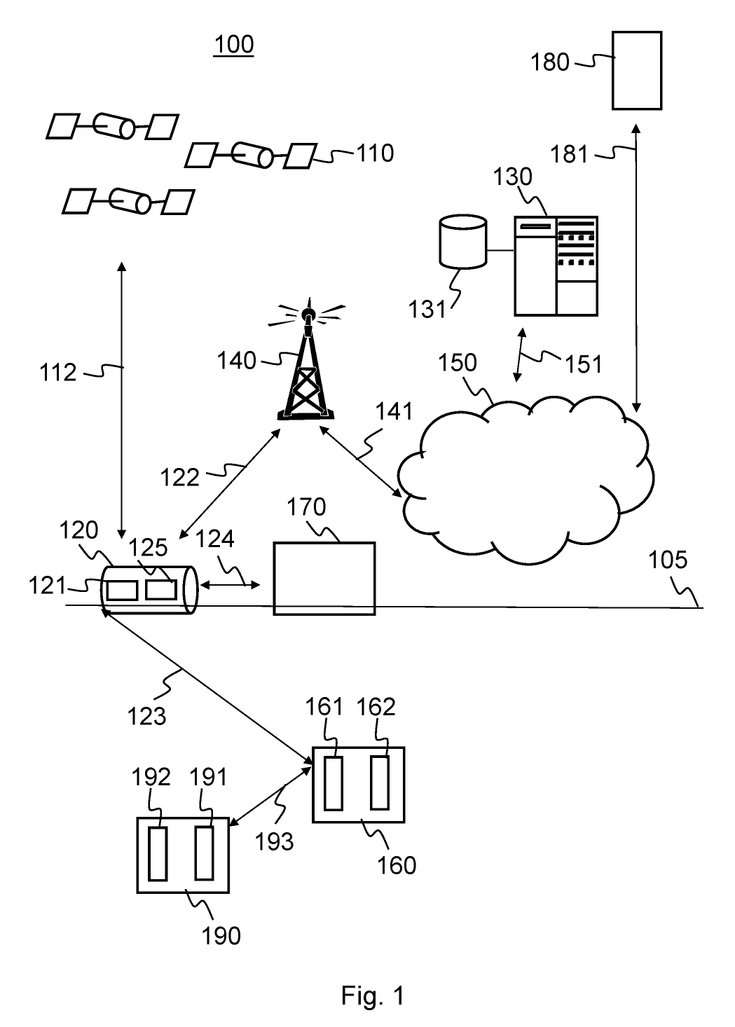

FIG. 1 shows a schematic picture of a system 100 according to an example embodiment of the invention. The system 100 comprises a plurality of satellites 110 in orbit about the Earth. The orbit of each satellite 110 is not necessarily synchronous with the orbits of other satellites and, in fact, is likely asynchronous. A global positioning system receiver apparatus such as the ones described in connection with preferred embodiments of the present invention is shown receiving spread spectrum global positioning system (GPS) satellite signals 112 from the various satellites 110.

A floating communication device 120 is positioned on a surface 105 of the water. The floating communication device 120 comprises a waterproof casing comprising a wireless communication interface 121 for transceiving data with the plurality of satellites 110 and a wireless communication network 140, for example. The floating communication device 120 further comprises an electromagnetic wave radiation cable 123 attached to an external surface of the waterproof casing and inductively coupled to the wireless communication interface 121 to transceive radio frequency signals between the wireless communication interface 121 and an underwater communication device 160.

In an embodiment, the wireless communication interface 121 may comprise at least one of the following:

a wireless cellular network interface for transceiving data with the wireless communication network 140 over a wireless connection 122;

a satellite based positioning system interface for transceiving data with the plurality of satellites 110 a wireless connection 112; and

a wireless non-cellular network interface for transceiving data with another floating device, such as a boat 170, over a wireless connection 124.

In an embodiment, a first end of the electromagnetic wave radiation cable 123 comprises a passive antenna that is arranged above a surface of water 105. Alternatively, the first end of the passive antenna is arranged below a surface of water 105.

In an embodiment, floating communication device 120 is capable of downloading and locally executing software program code. The software program code may be a client application of a service whose server application is running on a server apparatus 130 of the system 100.

The floating communication device 120 may comprise an environmental and capturing element 125, such as a wind sensor, a barometer, a GPS receiver and a flute height sensor, for example. The floating communication device 120 is configured to be connectable to a wireless communication network 140 over a wireless connection 122. The wireless connection 122 may comprise a mobile cellular network or a wireless local area network (WLAN), for example. The wireless communication network may be to a public data communication network 150, for example the Internet, over a data connection 141. The wireless connection 122 may also comprise a mobile non-cellular network, such as Bluetooth or satellite based communication system, for example.

Furthermore, the environmental and capturing element 125 may comprise a camera for providing still images and video streams above the surface of water 105, a solar cell for providing light detection or solar power. The environmental and capturing element 125 may also comprise sensors to measure water or atmosphere properties, and radiation, for example.

The environmental and capturing element 125 may also comprise data processing devices, memories, processors and software components to process and assist in handling the data collected by sub-sea units. For example, image processing may be done at the floating device 120 based on acoustic data from the underwater device 160. The processed result is sent back from the floating device 120 to the underwater device 160 as visual output.

An underwater communication device 160 may comprise a mobile phone, an Internet tablet, a mobile terminal or a laptop computer, for example. The underwater communication device 160 is capable of downloading and locally executing software program code. The software program code may be a client application of a service whose server application is running on the server apparatus 130 of the system 100.

The underwater communication device 160 comprises a waterproof casing comprising a wireless communication interface 161 for transceiving data with the floating communication device 120, for example. The underwater communication device 160 further comprises an electromagnetic wave radiation cable 123 attached to an external surface of the waterproof casing and inductively coupled to the wireless communication interface 161 to transceive radio frequency signals between the wireless communication interface 161 and the floating communication device 120.

The underwater communication device 160 may comprise an environmental and current activity data capturing element 162, such as a temperature sensor, a pressure sensor or a microphone, for example.

The data connection 123 may comprise a cable for wireless charging. The wireless charging may be implemented by a passive antenna in at least one end of the cable, wherein the end of the cable is attached to an external cover of the device 120, 160. The charging cable 123 may comprise a low-frequency antenna cable to minimize any energy loss during the cable. Under the surface of the water the wireless charging may be used through the water resistant casing of the device 160 since the wireless path traveled is short and used frequencies are low.

In an embodiment, a second underwater communication device 190 may comprise a mobile phone, an Internet tablet, a mobile terminal or a laptop computer, for example. The second underwater communication device 190 is capable of downloading and locally executing software program code. The software program code may be a client application of a service whose server application is running on the server apparatus 130 of the system 100.

The second underwater communication device 190 comprises a waterproof casing comprising a wireless communication interface 191 for transceiving data with the first underwater communication device 160, for example. The second underwater communication device 190 further comprises an electromagnetic wave radiation cable 193 attached to an external surface of the waterproof casing and inductively coupled to the wireless communication interface 191 to transceive radio frequency signals between the wireless communication interface 191 and the first underwater communication device 160. The second underwater communication device 190 may be used without a cable connected to the floating communication device 120.

The second underwater communication device 190 may comprise an environmental and current activity data capturing element 192, such as a temperature sensor, a pressure sensor or a microphone, for example.

The data connection 193 may comprise a cable for wireless charging. The wireless charging may be implemented by a passive antenna in at least one end of the cable, wherein the end of the cable is attached to an external cover of the device 160, 190. The charging cable 193 may comprise a low-frequency antenna cable to minimize any energy loss during the cable. Under the surface of the water the wireless charging may be used through the water resistant casing of the device 190 since the wireless path traveled is short and used frequencies are low.

In an embodiment, a first underwater communication device 160 and a second underwater communication device 190 may be connected underwater using a data connection 193 even without a data connection 123 between the first underwater communication device 160 and the floating communication device 120.

In an embodiment, the first underwater communication device 160 may comprise a computer apparatus, such as a tablet, and the second underwater communication device 190 may comprise an underwater measurement device comprising a wireless transceiver 191, such as a wireless LAN, Bluetooth or a NFC interface, for example.

In an embodiment, the system 100 may further comprise a remote device 180 that is connected over a connection 181 to the network 150 and is capable of communicating with the floating communication device 120 and via the floating communication device 120 also the underwater communication device 160 using the connection 123.

In an embodiment, a plurality of underwater communication devices 160 may be arranged in the system 100. The plurality of underwater communication devices 160 may communicate with each other by using the floating communication device 120 as an access point. Thus, a high-speed wireless local area network may be provided for the underwater devices 160, 190.

An electromagnetic wave radiation cable 123, 193 may be attached in first end to an external surface of a waterproof casing and inductively coupled to a wireless communication interface of a first device, and in second end to a physical connector of a second device to transceive radio frequency signals between the wireless communication interfaces of the first and the second device. Alternatively both cable ends may be connected inductively.

In an embodiment, at least one of the devices 120, 160, 190 may comprise an acoustic underwater positioning system for tracking and navigation of underwater devices or divers by means of acoustic distance and/or direction measurements, and subsequent position triangulation.

In an embodiment, an electromagnetic wave radiation cable 123, 193 may comprise at least one sensor configured to indicate shape, direction or angle of the cable. Based on the indication information provided by the sensor(s) and the length information of the cable 3D shape of the cable may be determined and thus the exact location of the end of the cable underwater.

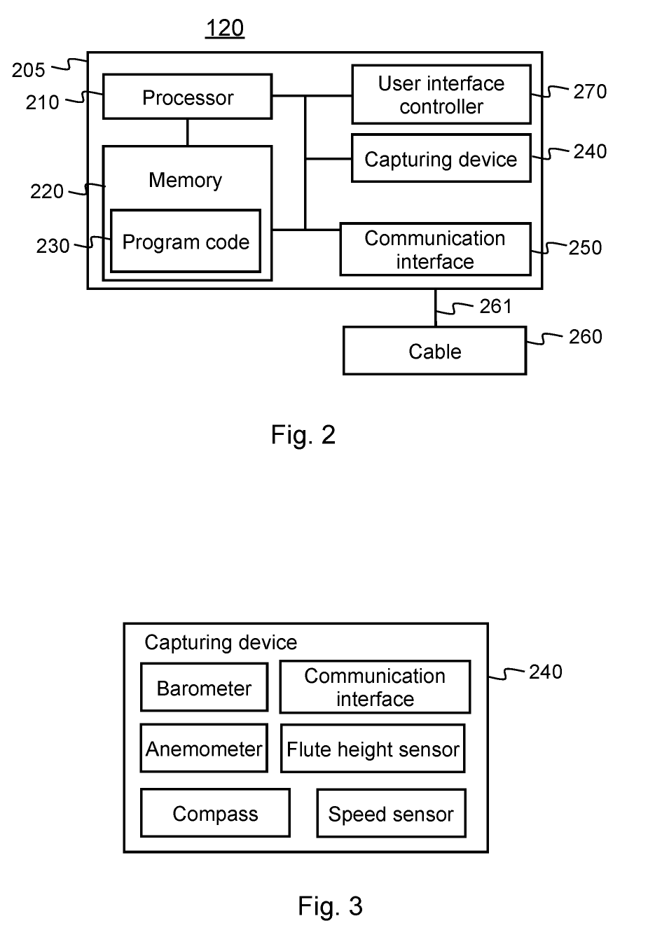

FIG. 2 presents an example block diagram of a floating communication device 120 in which various embodiments of the invention may be applied.

The general structure of the floating communication device 120 comprises a waterproof casing 205, a communication interface 250, a capturing device 240 for capturing any activity data and environmental data, a processor 210, and a memory 220 coupled to the processor 210. An electromagnetic wave radiation cable 260 is connected to the external surface of the waterproof casing 205 and is connected to the communication interface 250 via a passive antenna 261. The floating communication device 120 further comprises software 230 stored in the memory 220 and operable to be loaded into and executed in the processor 210. The software 230 may comprise one or more software modules and can be in the form of a computer program product. The floating communication device 120 may further comprise a user interface controller 270.

The processor 210 may be, e.g., a central processing unit (CPU), a microprocessor, a digital signal processor (DSP), a graphics processing unit, or the like. FIG. 2 shows one processor 210, but the floating communication device 120 may comprise a plurality of processors.

The memory 220 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The floating communication device 120 may comprise a plurality of memories. The memory 220 may be constructed as a part of the floating communication device 120 or it may be inserted into a slot, port, or the like of the floating communication device 120 by a user. The memory 220 may serve the sole purpose of storing data, or it may be constructed as a part of an apparatus serving other purposes, such as processing data. Any activity or monitoring application, activity data and environmental data may be stored to the memory 220.

The user interface controller 270 may comprise circuitry for receiving input from a user of the floating communication device 120, e.g., via keys, graphical user interface, speech recognition circuitry, or an accessory device. However, the floating communication device may not comprise a user interface at all.

The communication interface module 250 implements at least part of data transmission. The communication interface module 250 may comprise, e.g., a wireless or wired interface module. The wireless interface may comprise such as a WLAN, Bluetooth™, Infrared (IR), Radio Frequency Identification (RF ID), GSM/GPRS, CDMA, WCDMA, or LTE (Long Term Evolution) radio module. The wired interface may comprise such as universal serial bus (USB) or National Marine Electronics Association (NMEA) 0183/2000 standard for example. The communication interface module 250 may be integrated into the floating communication device 120, or into an adapter, card or the like that may be inserted into a suitable slot or port of the floating communication device 120. The communication interface module 250 may support one radio interface technology or a plurality of technologies. The floating communication device 120 may comprise a plurality of communication interface modules 250.

The communication interface 250 may also comprise a satellite positioning device is configured to provide location information. Such information may comprise, for example, position coordinates, speed, direction of movement; and slope information.

A skilled person appreciates that in addition to the elements shown in FIG. 2, the floating communication device 120 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the floating communication device 120 may comprise a disposable or rechargeable battery (not shown) for powering when external power if external power supply is not available and solar cells for charging batteries.

In an embodiment, the floating communication device 120 comprises speech recognition means. Using these means, a pre-defined phrase may be recognized from the speech and translated into control information for the floating communication device 120, for example.

The capturing device 240 may be configured to be comprised by the floating communication device 120 or connected as separate devices to the floating communication device 120. In case the capturing device 240 is comprised in the floating communication device 120 it may be connected to the floating communication device 120 using an internal bus of the floating communication device 120. In case the capturing device 240 is an external device connected to the floating communication device 120 it may be connected to the floating communication device 120 using communication interface 250 of the floating communication device 120 or using the internal bus.

In an embodiment, the passive antenna 261 may be attached to the outer casing 205 of the floating communication device 120, above or under the waterline. When placed above the waterline, the distance to the wireless communication interface 250 (e.g. WLAN/Bluetooth) inside the floating communication device 120 can be up to the range of these devices in air, but the closer the antenna 261 is placed, the stronger the signal is.

Below the waterline, the underwater device 160 (see FIG. 1 or 5) to be used within the wireless (e.g. WLAN/Bluetooth) network should be within a few centimeters of the passive antenna 262 (see FIG. 5) to ensure sufficient signal passage.

In an embodiment, the passive antenna 261, 262 may consist a coaxial, low-impedance antenna cable rated for microwave frequencies. At each end of the cable 260 the antennas 261, 262 are adjusted for the frequencies used: for 2.4 GHz, a simple full-wave length antenna would be 125 mm long and half wave length 613 mm. The antenna may be straight, coiled or directed, for example.

More than one passive antenna 261, 262 can be used to transmit data. The distinct antennas can be used to drive parallel data transmission processes by using different radio frequencies to avoid radio interference. A plurality of cables 260 may also be used.

FIG. 3 presents an example block diagram of a capturing device 240 in which various embodiments of the invention may be applied. The capturing device 240 may comprise various means for activity data detection and environmental data detection, for example.

In an embodiment, the capturing device 240 may comprise at least one of the following devices:
an anemometer for providing wind information;
a wind sensor for providing wind information;
a sensor for providing flute height information;
a barometer for measuring air pressure;
a temperature sensor for measuring environmental temperature;
a water depth sensor for measuring depth information;
a radiation sensor;
a solar cell for detecting light or providing solar power;
a chart plotter for providing position information;
a speed sensor for providing speed information;
a camera for providing images or a video signal; and
a compass for providing direction information.

The capturing device 240 may also comprise several capturing devices 240, combinations of any above mentioned devices, and the like. The environmental temperature may comprise air temperature, water temperature or ground surface temperature, for example.

In an embodiment, a wind sensor 240 is configured to determine or measure wind angle and wind speed. The wind sensor 240 may comprise any element of combination of elements operable to sense wind-related information for use by the floating communication device 120. For example, the wind sensor 240 may be operable to sense apparent wind speed, apparent wind angle, true wind speed, true wind angle, wind velocity made good (VMG), combinations thereof, and the like.

In an embodiment, a camera 240 is configured to provide video signal or still images. Based on the camera signal the floating communication device 120 may determine at least part of the environmental data. For example flute height may be determined based on the video signal from the video camera 240. The determination may be done by video image processing, pattern recognition, measuring a rocking movement or relative movement of a horizon, for example.

The capturing device 240 may comprise communication interface module implementing at least part of data transmission. The communication interface module may comprise, e.g., a wireless or a wired interface module. The wireless interface may comprise such as a WLAN, Bluetooth, infrared (IR), radio frequency identification (RF ID), GSM/GPRS, CDMA, WCDMA, or LTE (Long Term Evolution) radio module. The wired interface may comprise such as universal serial bus (USB) or National Marine Electronics Association (NMEA) 0183/2000 standard for example. The communication interface module may be integrated into the capturing device 240, or into an adapter, card or the like that may be inserted into a suitable slot or port of the capturing device 240. The communication interface module may support one radio interface technology or a plurality of technologies. The capturing device 240 may comprise a plurality of communication interface modules.

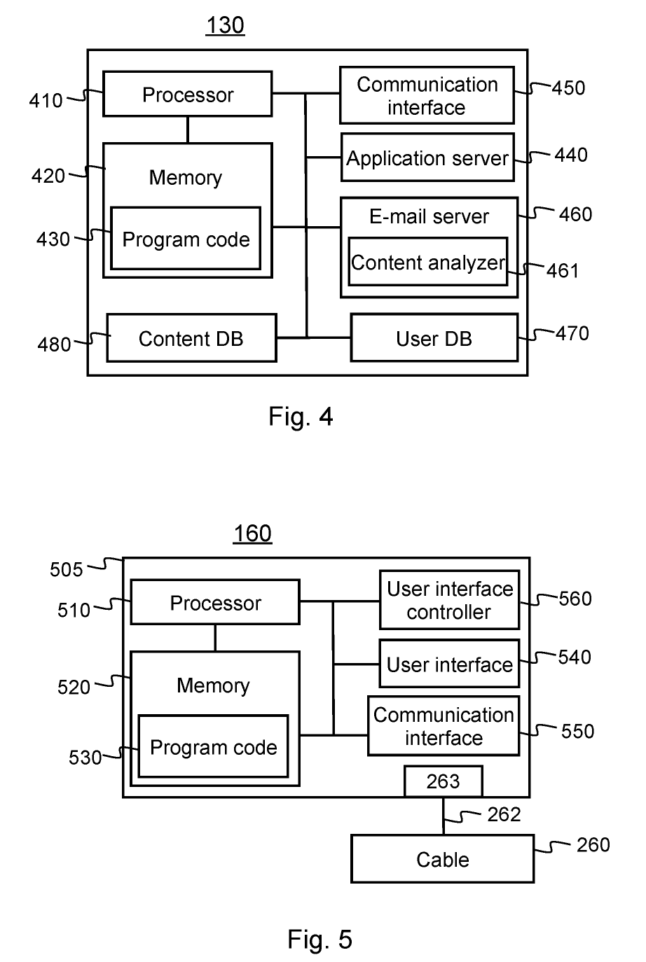

FIG. 4 presents an example block diagram of a server apparatus 130 in which various embodiments of the invention may be applied.

The general structure of the server apparatus 130 comprises a processor 410, and a memory 420 coupled to the processor 410. The server apparatus 130 further comprises software 430 stored in the memory 420 and operable to be loaded into and executed in the processor 410. The software 430 may comprise one or more software modules and can be in the form of a computer program product.

The processor 410 may be, e.g., a central processing unit (CPU), a microprocessor, a digital signal processor (DSP), a graphics processing unit, or the like. FIG. 4 shows one processor 410, but the server apparatus 130 may comprise a plurality of processors.

The memory 420 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The server apparatus 130 may comprise a plurality of memories. The memory 420 may be constructed as a part of the server apparatus 130 or it may be inserted into a slot, port, or the like of the server apparatus 130 by a user. The memory 420 may serve the sole purpose of storing data, or it may be constructed as a part of an apparatus serving other purposes, such as processing data.

The communication interface module 450 implements at least part of radio transmission. The communication interface module 450 may comprise, e.g., a wireless or a wired interface module. The wireless interface may comprise such as a WLAN, Bluetooth, infrared (IR), radio frequency identification (RF ID), GSM/GPRS, CDMA, WCDMA, or LTE (Long Term Evolution) radio module. The wired interface may comprise such as universal serial bus (USB), for example. The communication interface module 450 may be integrated into the server apparatus 130, or into an adapter, card or the like that may be inserted into a suitable slot or port of the server apparatus 130. The communication interface module 450 may support one radio interface technology or a plurality of technologies. Captured activity data and/or environmental data from the floating communication device 120 may be received by the server apparatus 130 using the communication interface 450.

The e-mail server process 460, which receives e-mail messages sent from the floating communication device 120 and remote apparatuses 180 via the network 150. The server 460 may comprise a content analyzer module 461, which checks if the content of the received message meets the criteria that are set for new activity data item of the service. The content analyzer module 461 may for example check whether the e-mail message contains a valid data item to be used within the system 100. The valid data item received by the e-mail server is then sent to an application server 440, which provides application services e.g. relating to the user accounts stored in a user database 470 and content of the content management service. Content provided by the service system 100 is stored in a content database 480.

A skilled person appreciates that in addition to the elements shown in FIG. 4, the server apparatus 130 may comprise other elements, such as microphones, displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like.

FIG. 5 presents an example block diagram of an underwater device 160 in which various embodiments of the invention may be applied. The underwater device 160 may be a user equipment (UE), user device or apparatus, such as a mobile terminal, a smart phone, an Internet tablet, or other communication device.

The general structure of the underwater device 160 comprises a waterproof casing 505, a user interface 540, a communication interface 550, a processor 510, and a memory 520 coupled to the processor 510. An electromagnetic wave radiation cable 260 is connected to the external surface of the waterproof casing 505 and is connected to the communication interface 550 via a passive antenna 262. The underwater device 160 further comprises software 530 stored in the memory 520 and operable to be loaded into and executed in the processor 510. The software 530 may comprise one or more software modules and can be in the form of a computer program product. The underwater device 160 may further comprise a user interface controller 560.

In an embodiment, the cable 260 may also comprise a plurality of cables 260. For example, a first cable 260 may be connected between a floating communication device 120 and a first underwater device 160, whereas a second cable 260 may be connected between the first underwater device 160 and a second underwater device 190,

The processor 510 may be, e.g., a central processing unit (CPU), a microprocessor, a digital signal processor (DSP), a graphics processing unit, or the like. FIG. 5 shows one processor 510, but the underwater device 160 may comprise a plurality of processors.

The memory 520 may be for example a non-volatile or a volatile memory, such as a read-only memory (ROM), a programmable read-only memory (PROM), erasable programmable read-only memory (EPROM), a random-access memory (RAM), a flash memory, a data disk, an optical storage, a magnetic storage, a smart card, or the like. The underwater device 160 may comprise a plurality of memories. The memory 520 may be constructed as a part of the underwater device 160 or it may be inserted into a slot, port, or the like of the underwater device 160 by a user. The memory 520 may serve the sole purpose of storing data, or it may be constructed as a part of an apparatus serving other purposes, such as processing data.

The user interface controller 560 may comprise circuitry for receiving input from a user of the underwater device 160, e.g., via a keyboard, touch interface, graphical user interface shown on the display of the user interfaces 540 of the underwater device 160, speech recognition circuitry, or an accessory device.

The communication interface module 550 implements at least part of radio transmission. The communication interface module 550 may comprise, e.g., a wireless or a wired interface module. The wireless interface may comprise such as a WLAN, Bluetooth™, Infrared (IR), Radio Frequency Identification (RF ID), GSM/GPRS, CDMA, WCDMA, or LTE (Long Term Evolution) radio module. The wired interface may comprise such as universal serial bus (USB) or National Marine Electronics Association (NMEA) 0183/2000 standard for example. The communication interface module 550 may be integrated into the underwater device 160, or into an adapter, card or the like that may be inserted into a suitable slot or port of the underwater device 160. The communication interface module 550 may support one radio interface technology or a plurality of technologies. The underwater device 160 may comprise a plurality of communication interface modules 550. Data items may be downloaded from the server apparatus 130 via the floating communication device 120, processed and stored to the underwater device 160. Stored data items may also be transferred from the underwater device 160 to the floating communication device 120 and therefrom to the server apparatus 130, for example.

A skilled person appreciates that in addition to the elements shown in FIG. 5, the underwater device 160 may comprise other elements, such as microphones, extra displays, as well as additional circuitry such as input/output (I/O) circuitry, memory chips, application-specific integrated circuits (ASIC), processing circuitry for specific purposes such as source coding/decoding circuitry, channel coding/decoding circuitry, ciphering/deciphering circuitry, and the like. Additionally, the underwater device 160 may comprise a disposable or rechargeable battery (not shown) for wireless or wired powering when external power if external power supply is not available.

In an embodiment, an apparatus and a method are provided for protecting touch-sensitive device underwater using pressurized and non-conductive fluid.

In an embodiment, a waterproof casing 505 comprises an inner cavity configured to receive the touch sensitive device 510-560 and protecting the device from the external pressure and the water outside the casing 505.

A second underwater device 190 may correspond to an example block diagram of FIG. 5 example block diagram of the underwater device 160 in which various embodiments of the invention may be applied. However, not necessarily all elements of FIG. 5 need to be implemented in the second underwater device 190. For example user interface 540 and user interface controller 560 may be optional.

In an embodiment, passive antenna attachment 263 may be implemented to any of the devices 120, 160, 190. The passive antenna attachment 263 may comprise a recess, a groove or similar shaped element for the passive antenna 262. Such attachment 263 helps a user to place the passive antenna 262 to an optimal position and direction for transceiver operation. The waterproof casing 505 may be shaped to comprise the attachment 263. The attachment 263 may also comprise locking mechanism to lock and release the passive antenna 262 to and from the attachment 263 by the user. The attachment 263 may comprise a casing part manufactured from a radio frequency (RF) transparent material, such as plastic, to ensure the radio frequency (RF) signals passing through the casing 505 between the cable 260 and the internal communication interface 550. Other parts of the casing 505 may be made of radio frequency (RF) non-transparent material, such as metal, for example.

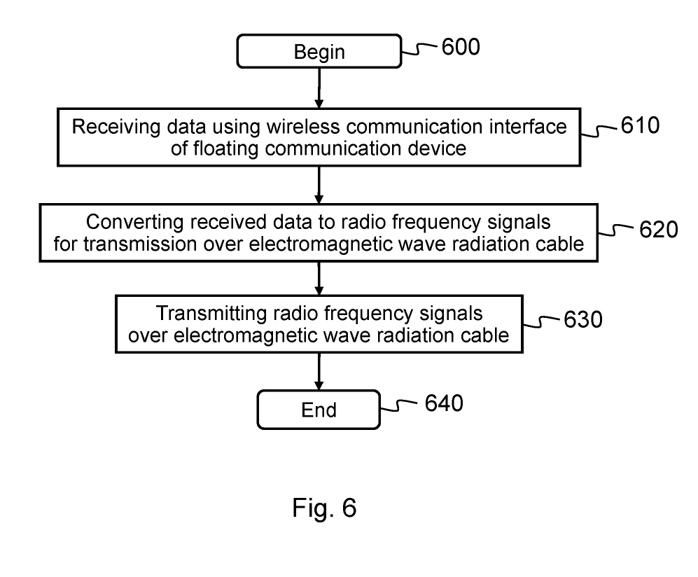

FIG. 6 shows a flow diagram showing operations in accordance with an example embodiment of the invention.

In step 600 a method for providing radio frequency signals between a floating communication device and an underwater communication device is started. In step 610, data is received using a wireless communication interface of the floating communication device. In step 620, the received data is converted to radio frequency signals for transmission over an electromagnetic wave radiation cable. In step 630, the radio frequency signals are transmitted from the wireless communication interface of the floating communication device over the electromagnetic wave radiation cable to an underwater communication device. In step 640, the method is ended. Steps 610-630 may also be done in opposite direction where in step 610, data is received using a wireless communication interface of the underwater communication device. In step 620, the received data is converted to radio frequency signals for transmission over an electromagnetic wave radiation cable. In step 630, the radio frequency signals are transmitted from the wireless communication interface of the underwater communication device over the electromagnetic wave radiation cable to a floating communication device.

In an embodiment, there is provided a wireless underwater communication device comprising:

a waterproof casing comprising a wireless communication interface for transceiving data; and

an electromagnetic wave radiation cable attached to an external surface of the waterproof casing and inductively coupled to the wireless communication interface to transceive radio frequency signals between the wireless communication interface and another wireless underwater communication device.

Some of the advantages provided by embodiments of the invention comprise at least one of the following. First, a wireless communication interface of an underwater communication device is enabled. Second, waterproof casings can be used both in the floating communication device and the underwater communication device without need for arranging holes for cables through the casing. Third, a wide variety of different wireless radio related signals can be transceived between the floating device and the underwater communication device. Fourth, no fixed attachment between the connection cable and either end of the devices is needed. Fifth, manufacturing costs and time is reduced. Sixth, interoperability of the floating communication device with different underwater devices is improved. Seventh, overall processing load may be balanced more easily.

Various embodiments have been presented. It should be appreciated that in this document, words comprise, include and contain are each used as open-ended expressions with no intended exclusivity. If desired, the different functions discussed herein may be performed in a different order and/or concurrently with each other. Furthermore, if desired, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented above, but that it can be implemented in other embodiments using equivalent means or in different combinations of embodiments without deviating from the characteristics of the invention.

Furthermore, some of the features of the above-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1-10. (canceled)

11. A floating communication device comprising:
a waterproof casing comprising a wireless communication interface for transceiving data;
an electromagnetic wave radiation cable attached to an external surface of the waterproof casing and inductively coupled to the wireless communication interface to transceive radio frequency signals between the wireless communication interface and an underwater communication device;
at least one processor; and
at least one memory including computer program code; wherein the at least one memory and the computer program code configured to, with the at least one processor, cause the floating communication device to:
receive data using the wireless communication interface;
convert the received data to radio frequency signals for transmission over the electromagnetic wave radiation cable; and
transmit the radio frequency signals from the wireless communication interface to the underwater communication device.

12. The floating communication device of claim 11, wherein the wireless communication interface comprising at least one of the following:
a wireless cellular network interface;
a satellite based positioning system interface; and
a wireless non-cellular network interface.

13. The floating communication device of claim 11, wherein the electromagnetic wave radiation cable comprising a passive antenna.

14. The floating communication device of claim 13, wherein the electromagnetic wave radiation cable comprising a plurality of electromagnetic wave radiation cables comprising a plurality of passive antennas.

15. A method for providing radio frequency signals between a floating communication device and an underwater communication device, the method comprising:
receiving data using a wireless communication interface of the floating communication device;
converting the received data to radio frequency signals for transmission over an electromagnetic wave radiation cable; and
transmitting the radio frequency signals from the wireless communication interface of the floating communication device over the electromagnetic wave radiation cable to the underwater communication device.

16. An underwater communication device comprising:
a waterproof casing comprising a wireless communication interface for transceiving data;
an electromagnetic wave radiation cable attached to an external surface of the waterproof casing and inductively coupled to the wireless communication interface to transceive radio frequency signals between the wireless communication interface and a floating communication device; and at least one processor; and
at least one memory including computer program code; wherein the at least one memory and the computer program code configured to, with the at least one processor, cause the underwater communication device to:
receive the radio frequency signals by the wireless communication interface from the floating communication device, wherein data are received using the wireless communication interface of the floating communication device and converted by the floating communication device to radio frequency signals for transmission over the electromagnetic wave radiation cable.

17. The underwater communication device of claim 16, further comprising:
a second electromagnetic wave radiation cable attached to the external surface of the waterproof casing and inductively coupled to the wireless communication interface to transceive radio frequency signals between the wireless communication interface and a second underwater communication device.

18. The underwater communication device of claim 17, wherein the waterproof casing further comprising:
a passive antenna attachment comprising a shaped element configured to guide a passive antenna to an operating position on a surface of the waterproof casing, wherein the attachment comprising a casing part manufactured from a radio frequency (RF) transparent material to pass radio frequency (RF) signals through the casing.

19. A system comprising:
a floating communication device of claim 11; and
an underwater communication device comprising:
a waterproof casing comprising a wireless communication interface for transceiving data;
an electromagnetic wave radiation cable attached to an external surface of the waterproof casing and inductively coupled to the wireless communication interface to transceive radio frequency signals between the wireless communication interface and a floating communication device; and at least one processor; and
at least one memory including computer program code; wherein the at least one memory and the computer program code configured to, with the at least one processor, cause the underwater communication device to:
receive the radio frequency signals by the wireless communication interface from the floating communication device, wherein data are received using the wireless communication interface of the floating communication device and converted by the floating communication device to radio frequency signals for transmission over the electromagnetic wave radiation cable.

20. A computer program embodied on a computer readable non-transitory medium comprising computer executable program code which, when executed by at least one processor of a floating communication device, causes the floating communication device to:
receive data using a wireless communication interface of the floating communication device;
convert the received data to radio frequency signals for transmission over an electromagnetic wave radiation cable; and
transmit the radio frequency signals from the wireless communication interface of the floating communication device over the electromagnetic wave radiation cable to an underwater communication device.
